(19) United States
(12) Patent Application Publication
(10) Pub. No.: US 2004/0067178 A1
(43) Pub. Date: Apr. 8, 2004

(54) Building ozone treatment system and method

(76) Inventor: Daniel Molleker, Bothell, WA (US)

Correspondence Address: Dean A. Craine, P.S., Suite 140, 400-112th Ave. NE, Bellevue, WA, 98004, US

(21) Appl. No.: 10/267,065

(22) Filed: Oct. 8, 2002

(51) Int. Cl. B01J 19/08; C23G 1/00

(52) U.S. Cl. 422/186.07; 134/2

(57) ABSTRACT

A system and method for treating a mold-infected building with hollow walls, ceilings, or floors using a relatively high concentration of ozone. The system includes an ozone generator that includes inlet and outlet ports that supply a constant, relatively low pressure flow of ozone to a continuous space formed inside a wall, floor, or ceiling. Special connectors are used that are inserted into two port openings formed on the wall that enables ozone to slowly flow into and out of the continuous space formed in the wall. The concentration of ozone and rate of flow is sufficient so that the ozone has sufficient time to kill the mold spores without dislodging them.

### BACKGROUND OF THE INVENTION

1. Field of the Invention

This invention pertains to systems and methods for disinfecting a building with hollow walls, ceilings, and floors, and more particularly, to such methods that use ozone.

2. Description of the Related Art

It is widely known that mold is a major health concern to homeowners. Everyone is exposed to some mold on a daily basis without harm and it is common to find mold spores in the air inside homes. Usually mold spores found indoors come from outdoor sources. Occasionally, however, the mold spores found indoors come from inside sources that usually lead to greater numbers of spores. The molds that grow inside a home are considered “active” and pose the greatest health problem to people inside the home.

Molds will grow and multiply when sufficient moisture and organic material is available. Because molds grow by digesting organic material, they gradually destroy whatever they grow on. Common indoor sources of moisture in a house include flooding, leaky roofs, sprinklers, plumbing leaks, overflow from sinks and sewers, and damp basements or crawl spaces. Once these moisture conditions arise, it is important that the source of the moisture be eliminated and that all wet surfaces be completely dried.

The most common way to detect mold is to look for discolored patches or speckled growth on porous walls or floors or to smell its earthy or musty odor. Unfortunately, because the spaces between the floors, walls, and ceilings are dark and often become wet, molds often thrive inside them.

Heretofore the current recommended method for removing mold from all porous surfaces inside a house has been to physically remove the surfaces upon which the mold grows. In addition to the expense of removal, a main drawback of removing such surfaces is that mold spores may be further disseminated throughout the house.

Recently, air cleansers with built-in ozone producing components have been developed that are designed to eradicate mold spores. Unfortunately, the ozone levels must exceed 2 PPM, typically regarded to be above safe health levels for humans and animals, for effective treatment.

What is needed is a simple system and method for treating the enclosed spaces in walls, ceilings, and floors of a house with ozone that does not require the removal or destruction of the affected surfaces.

### SUMMARY OF THE INVENTION

It is an object of the present invention to provide a system and method for treating the mold-contaminated, interior spaces in the hollow walls, floors, and ceilings of a building.

It is another object of the present invention that treatment of mold-contaminated interior surfaces does not require the removal of the contaminated surfaces or destruction of the walls, floors and ceilings.

It is another object of the present invention to use a sufficiently high concentration of ozone for use as a fungicide yet limit excess exposure of ozone to humans.

It is a further object of the present invention to limit the number of spores released into the central air space in the building during the treatment.

These and other objects of the present invention are met by the system and method disclosed herein that uses an ozone generator designed to produce a sufficiently high concentration of ozone capable of eradicating mold and mold spores. The ozone is mixed with air to create a mixture, hereinafter called ozonated air, that is circulated in the confined spaces located inside the hollow walls, ceilings, and floors of a building. The ozone generator, which constantly produces ozone in air when activated, is connected to a vacuum means and a blower means designed to slowly circulate ozonated air through a plurality of the interior spaces formed in a wall. Both the blower means and the vacuum means are connected to a plurality of flexible hoses that connect to wall connectors attached to the walls to circulate ozonated air in the interior spaces by the wall, ceiling and floor.

Walls, ceilings and floors are covered with particleboard, drywall, or other ozone impermeable material which confines the ozonated air to the interior space located therein. During assembly, inlet and outlet openings are formed on one surface of the wall, ceiling or floor. Typically, the walls, ceiling or floors are made of two panels separated with studs or other external frame members with an interior surface located therebetween. The frame members are normally spaced apart 12 to 24 inches on center. In the preferred embodiment, the inlet and outlet openings are spaced apart and longitudinally aligned on one side of the wall and between two frame members.

During use, ozonated air is forced into the interior spaces through the wall connectors. The ozonated air travels through the interior spaces and out through the second wall connector. The returned air is then mixed with fresh air and delivered to the ozone generator to return the level of ozone in the oxygenated air to the effective concentration to eradicate mold. In the preferred embodiment, the wall connectors include a main exit opening and a plurality of side mounted exit openings formed on their distal ends that allow ozonated air to easily escape or enter. The distal end surfaces of the wall connectors are serrated to easily cut through insulation material that may be located inside the interior space.

Using the above-described system, a method for treating mold in a building is also disclosed.

### DESCRIPTION OF THE DRAWINGS

FIG. 1 is a front elevational view of the system shown being used to treat mold inside a wall.

FIG. 2 is a top plan view of the system shown in FIG. 1.

FIG. 3 is a side elevational view of the system shown in FIGS. 2 & 3.

FIG. 4 is a side elevational view of the exhaust air inlet vessel.

FIG. 5 is a side elevational view of the three port wall connector.

FIG. 6 is a side elevational view of a single port wall connector.

### DESCRIPTION OF THE PREFERRED EMBODIMENT(S)

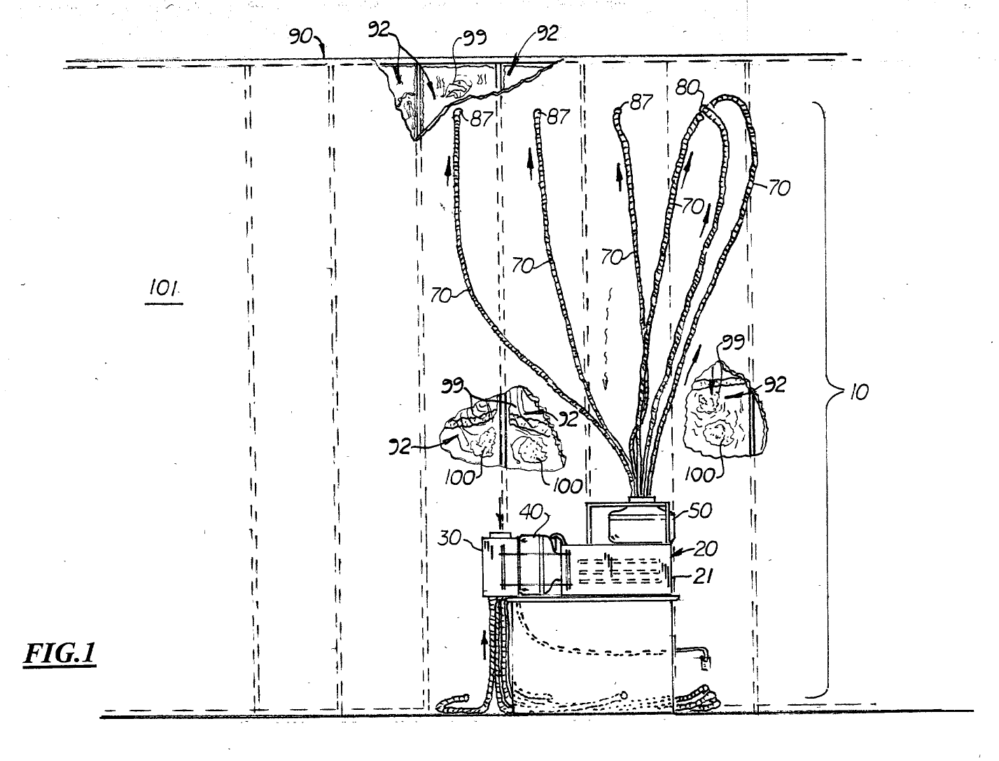

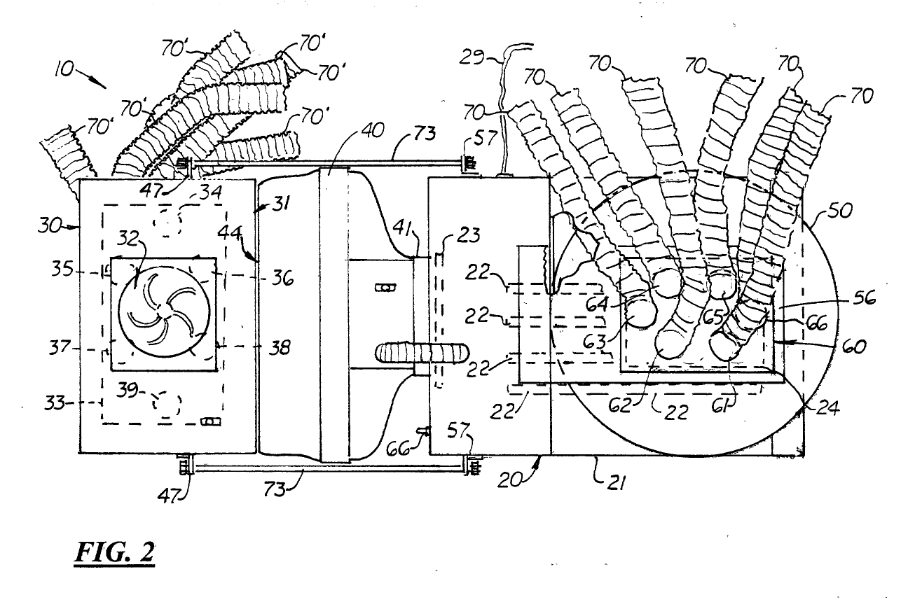

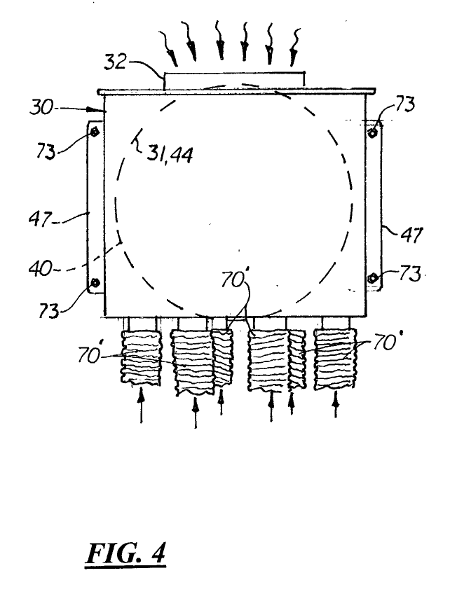

Shown in the accompanying FIGS. 1-7, there is shown a system and method for treating molds 100 in the interior spaces 92 located inside a hollow building support member 90, such as a studded wall, floor, or ceiling. The system 10 constantly produces an effective amount of ozone 98 which is transported to the interior spaces 92 inside the hollow building support member 90 and circulated therein at a relatively low rate so that the mold spores are not dislodged from the inner surfaces of the building support member 90 and into the environment. More specifically, the system 10 includes an ozone generator 20 used to produce a fungicidal concentration of ozone in air coupled to a first turbine 40 and a second turbine 50. The first turbine 40 acts as a vacuum means to slowly draw ozonated air 99 from the interior spaces 92 while the second turbine 50 acts as a blower means to force ozonated air 99 into the interior spaces 92. The size, shape and speed of the turbines 40, 50 are matched so that a slow constant flow of ozonated air 99 circulates (approximately 4 times per minute) inside the interior spaces 92. Because most wall paneling material, such as dry wall, is substantially impermeable to ozone and ozonated air 99, very little or no ozonated air 99 is released into the general air space 101 in the building. Because the half-life of ozone in air is relatively short, the ozonated air 99 is returned to the ozone generator 20 to replenish the ozone concentration.

The ozone generator 20 includes a closed, rigid box 21 with a plurality of ultraviolet/ozone producing lamps 22 disposed longitudinally therein that produce ozone in air when electrically activated. The rigid box 21 includes an inlet port 23 at one end which connects to the outlet opening 42 on a first turbine 40 and an opposite outlet port 24 that connects to a second turbine 50. The first turbine 40 includes an inlet opening 44 which communicates with an outlet opening 31 on an air exchange unit 30 located adjacent thereto. The air exchange unit 30 includes a large fresh air inlet port 32 and a manifold 33 with a plurality of small air return ports 34-39. During use, fresh air is drawn through the fresh air inlet port 32 and mixed with ozonated air 99 returned from the interior spaces 92 and through the return ports 34-39. The mixture of fresh air and returned ozonated air is then transmitted to the ozone generator 22 to produce ozone to a suitable concentration. In the preferred embodiment, the air exchange unit 30 includes six return ports 34-39 that slidingly connect to six air return tubes 70′. The air return tubes 70′ are approximately 8 feet in length and 2 inches in diameter.

In the preferred embodiment, the ozone generator 20 is manufactured by SCO Technologies Medallion Healthy Homes located in Bothell, Wash. (U.S.A.) (Model No. 03-9-14). The ozone generator 20 contains six to nine ultraviolet/ozone producing lamps 22 each approximately 14 inches in length, has a maximum air capacity of approximately 550 C.F.M and a maximum ozone saturation of 10 PPM. In the preferred embodiment, the ozone generator 20 produces 1 to 8 PPM of ozone in ozonated air 99. The ozonated air 99 inside the interior spaces 92 is circulated three to four times per minute.

As mentioned above, attached to the outlet port 24 on the ozone generator 20 is a second turbine 50. An outlet opening 56 on the second turbine 50 is connected to a manifold 60 that includes a plurality of delivery ports 61, each connected to one air delivery tube 70. In the embodiment shown in FIGS. 1-7, there are six delivery ports 61-66 and six air delivery tubes 70.

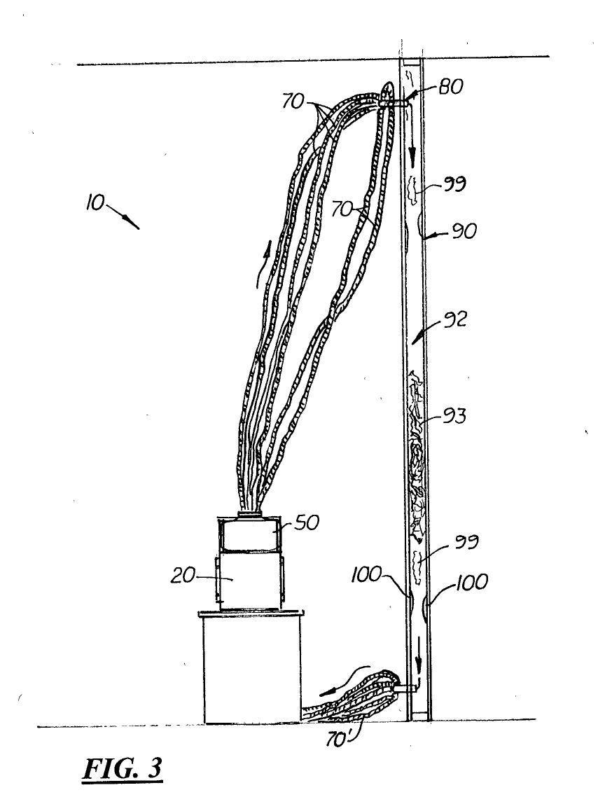

As shown in FIGS. 1 and 3, the distal ends of the air delivery tubes 70 and air return tubes 70′ are connected to one of two types of wall connectors 80, 87 inserted through inlet openings 91 and outlet openings 96 formed on one surface of the building support member 90. In the preferred embodiment, the openings 91 and 96 are slightly larger in diameter than the wall connectors 80, 87, to create an air tight fit therebetween. The openings 91 and 96 are spaced apart on the building support member 90 so that ozonated air 100 circulates through the entire interior space 92. Each inlet opening 91 and outlet opening 96 then slidingly receives one wall connector 80 or 87. In the preferred embodiment, the air delivery tubes 70 and air return tubes 70′ are approximately 8 feet in length and 2 inches in diameter.

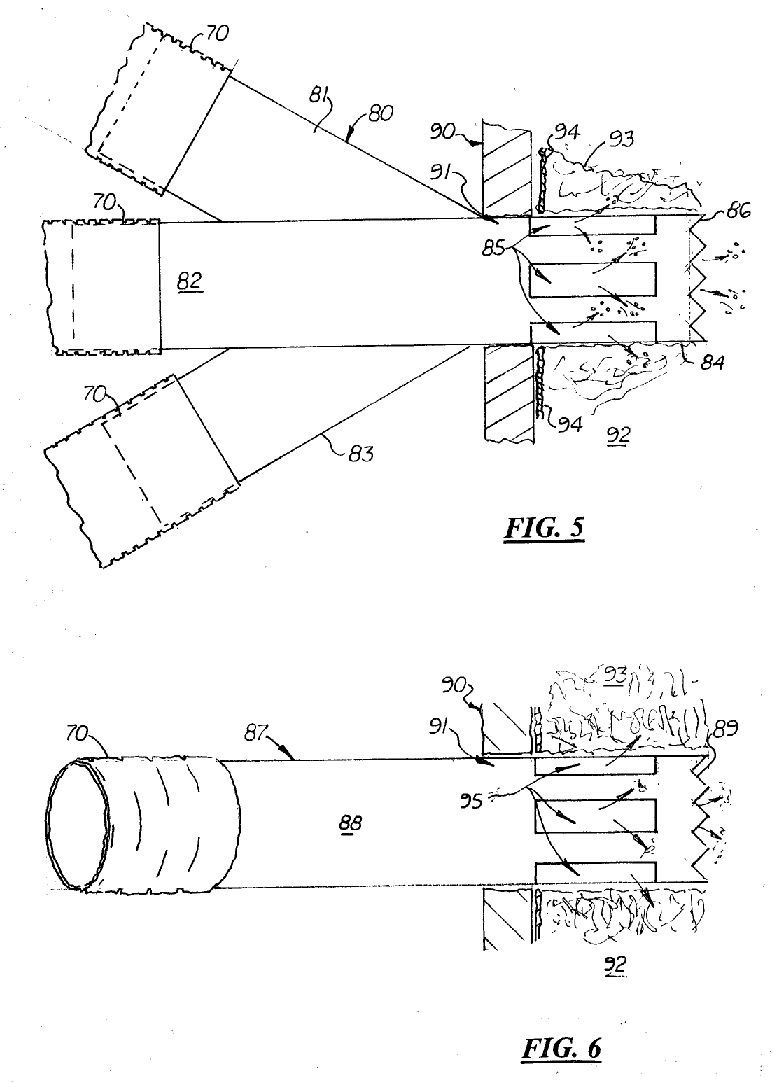

As shown in FIGS. 5 and 6, the first wall connector 80 includes three, triangularly aligned side ports 81, 82, 83 that converge towards a single, centrally aligned cylindrical member 84. The second wall connector 87 includes is a straight, cylindrical member 88. The distal end surfaces 86, 89 of the members 84, 88, respectively, are serrated which allows the wall connectors 80, 87 to easily cut through insulation 93 located inside the interior space 92. Both connectors 80, 87 are approximately two inches in diameter and include elongated side openings 85, 95 near the distal end surfaces 86, 89, respectively, that allow the ozonated air 99 to flow longitudinally and laterally into the interior spaces 92.

As shown in FIGS. 1-3, the first and second turbines 40, 50 are longitudinally aligned on opposite sides of the ozone generator 20. Brackets 47, 57 are mounted on the sides of the turbines 40, 50 which are interconnected with four rods 73 to securely hold them against the opposite sides of the ozone generator to airtight seals. The ozone generator 20 includes a power cord 29 that plugs into a standard 110 A.C. electrical outlet plug (not shown) to supply electricity to a master switch 66 mounted on the side of the rigid box 21. The master switch 66 operates the fan (not shown) and bulbs inside the ozone generator 20 and the first and second turbines, 40, 50, respectively.

During use, the ozone generator, vacuum and blower are activated for 15 to 60 minutes depending on the size of the building support structure, the amount of insulation, and the amount of mold. The fresh air is added to the system to ensure an adequate amount of ozone is generated and delivered to the interior space.

Using the above described system, a method of treating mold in a building with hollow building support structures comprising the following steps:

a. selecting a building support structure 90, such as a wall, floor or ceiling, with an interior space 92 formed therein with mold growing inside the interior space 92;

b. forming two openings 91, 96 on said building support structure to access the interior space 92 therein;

c. selecting a ozone generator system 10 including an ozone generator 20, a first turbine 40, a second turbine 50, a plurality of air delivery tubes 70, a plurality of air return tubes 70′;

d. inserting a wall connector 80 or 87 to said first opening 91 on said building support structure;

e. inserting a second wall connector 80 or 87 to said second opening 96 on said building support structure;

f. connecting one end of an air delivery tube 70 to said second turbine 50 and the opposite end of said air delivery tube to one said first wall connector;

g. connecting one end of an air return tube 70′ to said first turbine and the opposite end of said air return tube to one said second wall connector, and;

h. activating said ozone generator 20, said first turbine 40 and said second turbine 50 to create an maintain an ozone concentration between 1 to 8 PPM and slowly circulate ozonated air 99 through the interior space 92 in the building support structure.

In compliance with the statute, the invention described herein has been described in language more or less specific as to structural features. It should be understood, however, that the invention is not limited to the specific features shown, since the means and construction shown, is comprised only of the preferred embodiments for putting the invention into effect. The invention is therefore claimed in any of its forms or modifications within the legitimate and valid scope of the amended claims, appropriately interpreted in accordance with the doctrine of equivalents.

I claim:

1. A system for treating molds in a building made of hollow wall members, comprising:
a. an ozone generator;
b. a blower means connected to said ozone generator;
c. a vacuum means connected to said ozone generator, said vacuum source including a fresh air port;
d. at least one inlet wall connector inserted into a first opening formed in a wall to deliver ozone to said confined space located therein;
e. at least one outlet wall connector inserted into a second opening formed in a wall to remove ozone from said confined space;
f. an air delivery tube disposed between said blower means and said inlet wall connector; and,
g. an air return tube disposed between said vacuum means and said outlet wall connector.

2. The system as recited in claim 1, wherein said ozone generator produces ozone in a concentration of 1-8 PPM.

3. The system as recited in claim 2, wherein said blower means and vacuum means recirculates the ozone inside said hollow wall member four times per minute.

4. The system as recited in claim 2, wherein said inlet wall connectors and outlet wall connectors each include a serrated distal end surface.

5 A method of treating mold in a building with hollow building support structures, comprising the following steps:
a. selecting a building support structure 90, such as a wall, floor or ceiling with an interior space 92 formed therein with mold growing inside the interior space 92;
b. forming two openings 91, 96 on said building support structure to access the interior space 92 therein;
c. selecting a ozone generator system 10 including an ozone generator 20, a first turbine 40, a second turbine 50, a plurality of air delivery tubes 70, a plurality of air return tubes 70′;
d. inserting a wall connector 80 or 87 to said first opening 91 on said building support structure;
e. inserting a second wall connector 80 or 87 to said second opening 96 on said building support structure;
f. connecting one end of an air delivery tube 70 to said second turbine 50 and the opposite end of said air delivery tube to one said first wall connector;
g. connecting one end of an air return tube 70′ to said first turbine and the opposite end of said air return tube to one said second wall connector, and;
h. activating said ozone generator 20, said first turbine 40 and said second turbine 50 to slowly circulate ozonated air 99 with an ozone concentration between 1 to 8 PPM through said interior space 92.

6. The method as recited in claim 5, wherein said ozonated air is circulated in said interior space four times per minute.

7. A method of treating mold in a hollow building support structure, comprising the following steps:
a. selecting a hollow building support structure with mold located inside the interior space located therein;
b. selecting an ozone generator used to produce 1 to 8 PPM of ozone in the air;
c. connecting said ozone generator to said building support structure;
d. activating said ozone generator to produce 1-4 PPM;
e. recirculate said ozone through said building support structure.
